(19) United States
(12) Patent Application Publication
(10) Pub. No.: US 2013/0264330 A1
(43) Pub. Date: Oct. 10, 2013

(54) Medium Voltage Heater

(71) Applicants: Jack L. McClanahan, Montgomery, TX (US); Craig S. Tiras, Houston, TX (US)

(72) Inventors: Jack L. McClanahan, Montgomery, TX (US); Craig S. Tiras, Houston, TX (US)

(73) Assignee: Gaumer Company, Inc., Houston, TX (US)

(21) Appl. No.: 13/439,492

(22) Filed: Apr. 4, 2012

(51) Int. Cl. H05B 3/06

(52) U.S. Cl. 219/520

(57) ABSTRACT

An electrical heater has a number of heater elements, each having a metal tube with an exterior end and an interior end. An electrical resistance coil is located within the tube with a conductor pin connected to the coil and protruding from the tube. Electrical insulation powder surrounds the coil within the tube. A cavity within the end of the tube receives an insulating member having a passage through which the conductor pin extends. A layer of epoxy is located between the insulating member and the powder. The tubes are arranged into three electrical phase groups. Interior conductor pins of the groups are electrically connected to each other in a Y-configuration. A phase divider of electrical insulating material has three sections dividing the electrical phase groups of the conductor pins.

### FIELD OF THE DISCLOSURE

This application relates to electrical heaters for process heat exchangers, and in particular to electrical heaters for use with medium voltages.

### BACKGROUND OF THE DISCLOSURE

One type of electrical process heater used in various industries comprises a tank or pressure vessel having an inlet and an outlet for the liquid to flow through. The heater has a heater element bundle mounted in the tank. The heater element bundle has a number of electrical resistance heater elements. Each heater element includes a metal tube, an electrical resistance coil within the tube and embedded in an insulation powder, and an exterior conductor pin secured to the end of the coil. The heater has at least one end located outside of the tank, that end having a header to which each tube is secured. The opposite end may also include a header or the tubes may be U-shaped.

Voltage is applied to the conductor pins to create heat in the electrical resistance coils. Most process heat exchangers operate with three-phase power in the range from about 600 to 640 volts. More recently electrical heaters have been proposed to operate in the range from about 2,400 to 4,160 volts. Although considered a medium voltage for electrical power transmission in general, this voltage creates more demands on the heater elements.

The insulation powder is typically magnesium oxide packed tightly within the tube surrounding the coiled wire. While magnesium oxide provides excellent electrical insulation, it is a desiccant, thus it attracts moisture from the surrounding atmosphere. The penetration of moisture reduces the ability of the insulation powder to insulate.

In the past, heater elements of this nature have been kept in low humidity rooms and/or baked in an oven with their ends open to drive off any moisture. Then, when ready for use, the heater elements are mounted to a header plate and seals are placed over the open ends. For example, a liquid sealant may be poured over the open ends and cured. While these methods work, improving the resistance of the insulation is desirable not only for low voltage heaters but also for medium voltage heaters. The higher voltage is more difficult to insulate, particularly at the exposed end face of the insulation powder, which is subject to moisture penetration. U.S. Pat. No. 7,372,007 shows one type of electrical heater for medium voltages.

### SUMMARY

An electrical heater has a plurality of heater elements, each of the elements having a metal tube, an electrical resistance wire within the tube, an exterior conductor pin joined to the wire and protruding from an exterior end of the tube, and an electrical insulation powder surrounding the wire within the tube. A cavity is formed within the exterior end of the tube with the exterior conductor pin extending through the cavity. An electrical insulating member has a passage through which the exterior conductor pin extends. The insulating member has a cylindrical shank that is located in the cavity and a cylindrical head protruding from the exterior end of the tube. A layer of epoxy is located between the shank and the powder.

The heater has a header plate having a plurality of apertures. The tubes are joined to the header plate and the exterior conductor pins extend through the apertures. A housing is mounted to an exterior side of the header plate and encloses the exterior conductor pins.

A phase divider may insert into the housing in abutment with the header plate, the phase divider being of an electrical insulating material and having three sections that separate the exterior conductor pins into first, second and third electrical phase groups. The exterior conductor pins within the first group are adapted to be connected to a first phase of a three-phase voltage, the exterior conductor pins within the second group are adapted to be connected to a second phase of the three-phase voltage, and the exterior conductor pins within the third group are adapted to be connected to a third phase of the three-phase voltage.

The sections of the phase divider may join each other at a hub on a longitudinal axis of the housing and extend radially from the hub 120 degrees apart from each other. The phase divider may have a cylindrical wall surrounding and joined to peripheral edges of the sections.

Preferably each of the exterior conductor pins protrudes a same distance from the header plate. Each of the tubes may also have an interior end and an interior conductor pin protruding past the interior end. The interior conductor pins are separated into the same first, second and third groups as the exterior conductor pins. The interior conductor pins within each of the groups are electrically connected to each of the other of the interior conductor pins within the same group. The groups are connected to each other in a Y-configuration.

The end of the shank of the insulating member in contact with the epoxy layer may be flat and perpendicular to the exterior conductor pin. The head of the insulating member preferably has a shoulder that abuts the exterior end of the tube. An annular gap between the exterior conductor pin and the passage in the insulating member may have a layer of epoxy filling the annular gap.

### BRIEF DESCRIPTION OF THE DRAWINGS

FIG. 1 is a side view of two medium voltage heaters in accordance with this disclosure and shown mounted to a tank.

FIG. 2 is an enlarged sectional view of an exterior portion of one of the electrical heater tubes of one of the heaters of FIG. 1.

FIG. 3 is an enlarged sectional view of an interior portion of one of the electrical heater tubes of one of the heaters of FIG. 1.

FIG. 4 is a front view of the exterior end of one of heaters of FIG. 1.

FIG. 5 is a front view of the interior end of one of the heaters of FIG. 4.

FIG. 6 is a perspective view of a phase insulator for the heater illustrated in FIGS. 4 and 5.

### DETAILED DESCRIPTION

Referring to FIG. 1, a pressure vessel or tank 11 contains a fluid to be heated. Two or more electrical heaters 13 are illustrated as being installed in tank 11, but a single electrical heater 13 could be used. Electrical heaters 13 may operate outside of a tank 11, such as in a subsea environment.

In this embodiment, each electrical heater 13 has an exterior portion extending through a wall of tank 11. Each electrical heater 13 has an exterior header plate 15 mounted a selected standoff distance from tank 11. A cylindrical neck 17 is welded to tank 11, and header plate 15 is secured to neck 17. Each electrical heater 13 has a housing 19 secured to the side of header plate 15 opposite neck 17. Each electrical heater 13 also preferably has an interior end cover 21 located within tank 11. Each electrical heater 13 comprises a bundle of parallel heater elements 23.

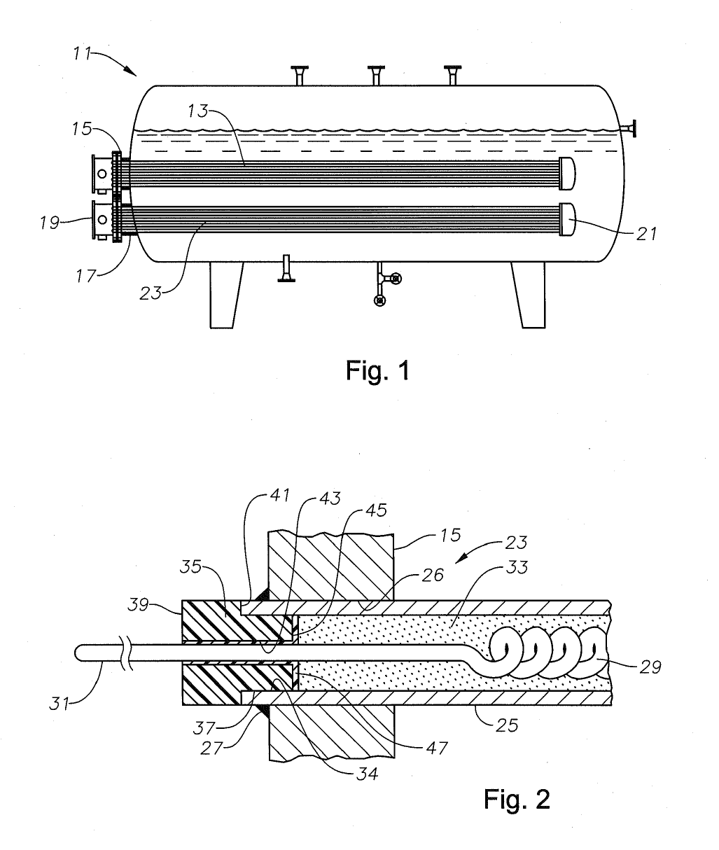

Referring to FIG. 2, each heater element 23 includes a metal tube 25 that extends through an aperture 26 in exterior header plate 15. An exterior end of each metal tube 25 is joined to exterior header plate 15, such as by a weld 27. The exterior end of tube 25 may protrude past header plate 15 a short distance. An electrical resistance wire 29 having a coiled portion locates within each tube 25. Wire 29 has a high electrical resistance for generating heat when electrical current passes through it. A typical material for wire 29 is a nickel-chromium alloy. An exterior conductor pin 31 joins wire 29 and protrudes past the end of tube 25. The term “pin” is used generically to include both a male electrical terminal as well as a female electrical terminal. In this embodiment, each exterior conductor pin 31 of one of the heater 13 has the same axial length from exterior header plate 15 as the other exterior conductor pins 31 within heater 13.

Wire 29 is electrically insulated from tube 25 by an insulation powder 33 such as magnesium oxide. Insulation powder 33 is packed tightly within tube 25 and prevents wire 29 from contacting the side walls of tube 25. The end of insulation powder 33 is recessed within tube 25 a selected distance, creating a cavity 34. The end of insulation powder 33 may be generally flat and perpendicular to an axis of tube 25.

An electrical insulation member 35 having a high dielectric value has a cylindrical shank 37 inserts into cavity 34. The material of insulation member 35 may be ceramic or any suitable high temperature dielectric material. Insulation member 35 has an enlarged cylindrical head 39 with a diameter larger than shank 37 and larger than the inner diameter of tube 25. Head 39 protrudes past the exterior end of tube 25 and has a shoulder 41 that abuts the exterior end of tube 25. Shank 37 has an outer diameter that fits snuggly within the inner diameter of tube 25 and need not form a seal. An axial passage 43 extends through insulation member 35 along the axis of tube 25. Exterior conductor pin 31 extends through passage 43 and is slightly smaller in diameter than passage 43, creating an annulus between. Insulation member 35 has an inner end 45 located within tube 25 that may be flat and perpendicular to the axis of tube 25.

A layer of epoxy 47 is located between the end of powder 33 and insulation member inner end 45. Epoxy 47 also extends into the annulus between exterior conductor pin 31 and the inner diameter of passage 43. Epoxy 47 is uncured when placed in tube 25, then subsequently cured to bond insulation member 35 to powder 33 and tube 25. Epoxy 47 forms a seal against the inner diameter of tube 25 at the end of powder 33, blocking moisture entry. Exterior conductor pin 31 protrudes past insulation member 35 a selected distance.

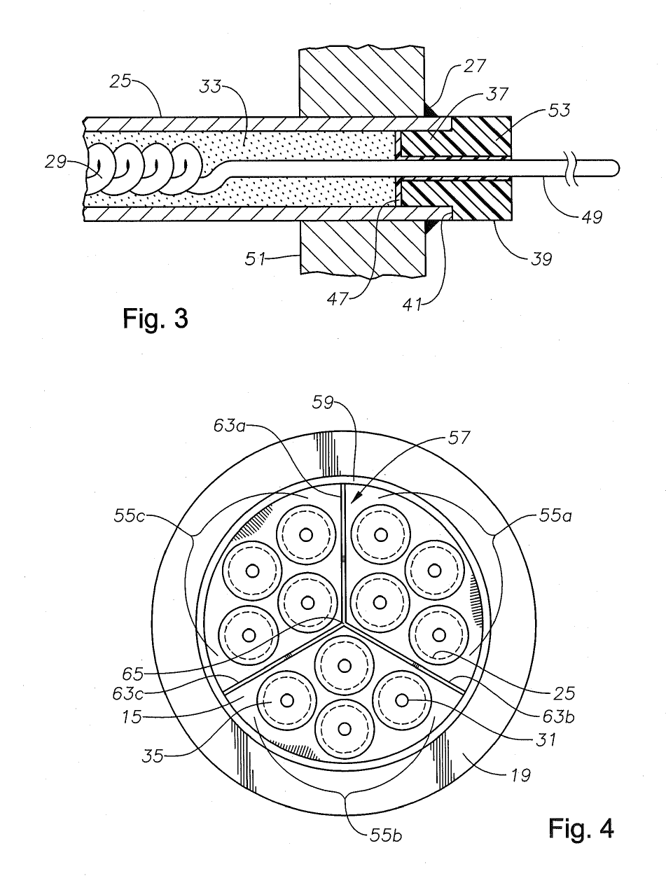

Referring to FIG. 3, each metal tube 25 is straight and has an interior conductor pin 49 joining the opposite end of wire 29. The terms “interior” and “exterior” are used only for convenience as heaters 13 (FIG. 1) may be employed within fluid exterior of any tank or vessel 11. The interior end of each tube 25 extends through an aperture in an interior header plate 51, which is located in cover 21 (FIG. 1). An interior insulation member 53 is secured within the interior end of tube 25 in the same manner as shown in FIG. 2. Features shown in FIG. 3 that are the same as in FIG. 2 are not discussed.

FIG. 4 shows a front view of one of the heaters 13. In this example, 12 separate heater elements 23 are mounted to exterior header plate 15, but more or fewer could be employed. Heater 13 is powered by three phase power, and elements 23 are grouped into electrical phase groups 55a, 55b and 55c. In this example, each phase group 55a, 55b, 55c has four heater elements 23. The heater elements 23 within each phase group 55a are bunched together; however, the portions of the metal tubes 25 on the exterior of header plate 15 are not touching each other in this example. Tubes 25 of phase group 55a are illustrated within a triangular segment extending from zero degrees to 120 degrees. Tubes 25 of phase group 55b are illustrated within a triangular segment extending from 120 degrees to 240 degrees. Tubes 25 of phase group 55c are illustrated within a triangular segment extending from 240 degrees to 360 degrees.

An exterior phase divider 57 formed of electrical insulation material divides the phase groups 55a, 55b and 55c from each other. Phase divider 57 has a cylinder 59 that slides closely into the inner diameter of housing 19. Three web sections 63a, 63b and 63c extend radially outward from a hub 65 and join cylinder 59. Web sections 63a, 63b and 63c are flat plates that separate the phase groups 55a, 55b and 55c from each other, as also illustrated in FIG. 6. Web sections 63a, 63b and 63c extend 120 degrees apart from each other from hub 65. The length of cylinder 59 and web sections 63a, 63b and 63c measured along a axis of housing 19 is at least the length of each exterior conductor pin 31 from exterior header plate 51 to the tips of exterior conductor pins 31, all of which are the same distance from exterior header plate 15.

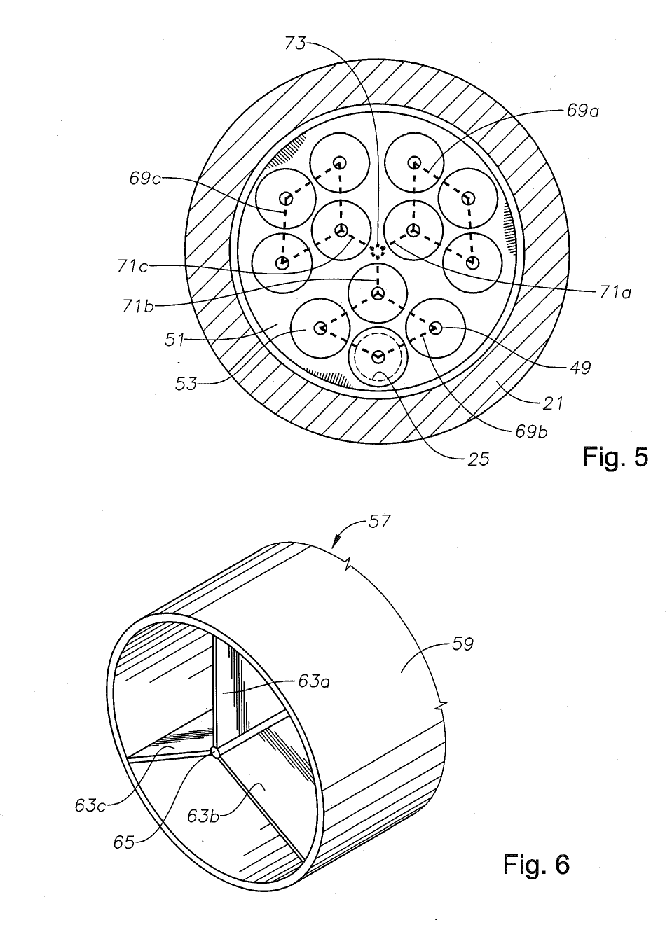

FIG. 5 shows that interior header plate 51 has the same three-phase arrangement for interior conductor pins 49 as exterior header plate 15 (FIG. 4). Electrical bus bars or leads 69a, shown schematically by dotted lines, electrically join each interior conductor pin 49 within phase group 55a. Bus bars 69b electrically join each interior conductor pin 49 within phase group 55b. Bus bars 69c electrically join each interior conductor pin 49 within phase group 55c.

The three bus bars 69a, 69b and 69c join each other, as indicated schematically by dotted lines 71a, 71b and 71c , forming a zero voltage neutral point 73. This arrangement defines a Y-configuration for three-phase power. The interior conductor pins 49 within each group 55a, 55b and 55c will receive a different electrical phase of the three-phase power supplied to groups 55a, 55b and 55c on the exterior end. The voltage at neutral point 73 should be approximately zero.

Referring to FIG. 1, heaters 13 are constructed to operate at a medium voltage in the range from about 2400 volts to 4,160 volts. Referring to FIG. 4, a power supply will be connected to exterior conductor pins 31 with one phase connected to exterior conductor pins 31 in group 55a, a second phase to exterior conductor pins 31 in group 55b, and a third phase to exterior conductor pins 31 in group 55c. Phase divider web sections 63a, 63b, and 63c, exterior insulation members 35 and epoxy layers 47 provide insulation to resist arcing between the different phases 55a, 55b and 55c. Epoxy layers 47 also seal insulation powder from moisture. The electrical power causes heat to be generated by resistance wires 29 (FIG. 2).

While the disclosure has been shown in only one of its forms, it should be apparent to those skilled in the art that it is not so limited but is susceptible to various changes without departing from the scope of the disclosure.

1. An electrical heater having a plurality of heater elements, each of the elements having a metal tube, an electrical resistance wire within the tube, an exterior conductor pin joined to the wire and protruding from an exterior end of the tube, and an electrical insulation powder surrounding the wire within the tube, the improvement comprising:
a cavity within the exterior end of the tube, the exterior conductor pin extending through the cavity;
an electrical insulating member having a passage through which the exterior conductor pin extends, a cylindrical shank that is located in the cavity and a cylindrical head protruding from the exterior end of the tube; and wherein
a layer of epoxy is located between the shank and the powder.

2. The heater according to claim 1, further comprising:
a header plate having a plurality of apertures, the tubes being joined to the header plate and the exterior conductor pins extending through the apertures;
a housing mounted to an exterior side of the header plate and enclosing the exterior conductor pins; and
a phase divider in the housing in abutment with the header plate, the phase divider being of an electrical insulating material and having three sections that separate the exterior conductor pins into first, second and third groups, the exterior conductor pins within the first group adapted to be connected to a first phase of a three-phase voltage, the exterior conductor pins within the second group adapted to be connected to a second phase of the three-phase voltage, and the exterior conductor pins within the third group adapted to be connected to a third phase of the three-phase voltage.

3. The heater according to claim 2, wherein the sections join each other at a hub on a longitudinal axis of the housing and extend radially from the hub 120 degrees apart from each other.

4. The heater according to claim 3, wherein the phase divider comprises a cylindrical wall surrounding and joined to peripheral edges of the sections.

5. The heater according to claim 2, wherein each of the exterior conductor pins protrudes a same distance from the header plate.

6. The heater according to claim 2, wherein:
each of the tubes has an interior end and an interior conductor pin joined to the wire and protruding past the interior end;
the interior conductor pins are separated into the same first, second and third groups as the exterior conductor pins;
the interior conductor pins within each of the groups are electrically connected to each of the other of the interior conductor pins within the same group; and
the groups are electrically connected to each other in a Y-configuration.

7. The heater according to claim 1, wherein the end of the shank of the insulating member in contact with the epoxy layer is flat and perpendicular to the exterior conductor pin.

8. The heater according to claim 1, wherein the head of the insulating member has a shoulder that abuts the exterior end of the tube.

9. The heater according to claim 1, further comprising:
an annular gap between the exterior conductor pin and the passage in the insulating member; and
a layer of epoxy filling the annular gap.

10. An electrical heater having a plurality of heater elements, each of the elements comprising:
a metal tube having an exterior end and an interior end;
an electrical resistance wire within the tube, an exterior conductor pin joined to one end of the wire and protruding from the exterior end of the tube, and an interior conductor pin joined to an opposite end of the wire and protruding from the interior end of the tube, and electrical insulation powder surrounding the wire within the tube;
an exterior cavity within the exterior end of the tube, the exterior conductor pin extending through the exterior cavity, and an interior cavity within the interior end of the tube, the interior conductor pin extending through the interior cavity;
an exterior insulating member having a passage through which the exterior conductor pin extends, a cylindrical shank that is located in the exterior cavity and a cylindrical head protruding from the exterior end of the tube;
an interior insulating member having a passage through which the interior conductor pin extends, a cylindrical shank that is located in the interior cavity and a cylindrical head protruding from the interior end of the tube;
a layer of epoxy located between the shank of the exterior insulating member and the powder and between the exterior conductor pin and the passage in the exterior insulating member; and
a layer of epoxy located between the shank of the interior insulating member and the powder and between the interior conductor pin and the passage in the interior insulating member.

11. The heater according to claim 10, further comprising:
an exterior header plate having a plurality of apertures, the exterior ends of the tubes being joined to the exterior header plate and the exterior conductor pins extending through apertures;
an interior header plate having a plurality of apertures, the interior ends of the tubes being joined to the interior head plate, and the interior conductor pins extending through the apertures of the interior header plate;
the tubes being arranged into first, second and third electrical phase groups, each of the groups containing at least two of the tubes;
the interior conductor pins of the tubes in each of the groups being electrically connected to each other; and
the interior conductor pins of the groups being electrically connected to each other in a Y-configuration.

12. The heater according to claim 11, further comprising:
a phase divider of electrical insulating material that has three sections, each section abutting the exterior header plate and extending axially therefrom at least to tips of the exterior conductor pins, each section extending between two of the groups.

13. The heater according to claim 12, wherein the sections of the phase divider join each other at a hub on a longitudinal axis of the exterior header plate and extend radially from the hub 120 degrees apart from each other.

14. The heater according to claim 13, wherein the phase divider comprises a cylindrical wall surrounding and joined to peripheral edges of the sections.

15. The heater according to claim 10, wherein:
the end of the shank of the exterior insulating member in contact with the epoxy layer is flat and perpendicular to the exterior conductor pin; and
the end of the shank of the interior insulating member in contact with the epoxy layer is flat and perpendicular to the interior conductor pin.

16. The heater according to claim 10, wherein:
the head of the exterior insulating member has a shoulder that abuts the exterior end of the tube; and
the head of the interior insulating member has a shoulder that abuts the interior end of the tube.

17. An electrical heater having a plurality of heater elements, each of the elements comprising:
a metal tube having an exterior end and an interior end;
an electrical resistance coil within the tube, an exterior conductor pin connected to one end of the coil and protruding from the exterior end of the tube, and an interior conductor pin connected to an opposite end of the coil and protruding from the interior end of the tube, and electrical insulation powder surrounding the coil within the tube;
an exterior header plate having a plurality of apertures, the exterior ends of the tube of each of the elements being joined to the exterior header plate and the exterior conductor pins extending through apertures;
an interior header plate having a plurality of apertures, the interior ends of the tube of each of the elements being joined to the interior head plate, and the interior conductor pins extending through the apertures of the interior head plate;
the tubes being arranged into first, second and third electrical phase groups, each of the groups containing at least two of the tubes;
the interior conductor pins of the tubes in each of the groups being electrically connected to each other;
the interior conductor pins of the groups being electrically connected to each other in a Y-configuration;
an exterior phase divider of electrical insulation material, the phase divider having a cylindrical periphery, a hub on an axis of the cylinder, and three web sections extending radially outward from the hub 120 degrees apart form each other; and
the phase divider being located with one end in abutment with the exterior header plate, the web sections dividing the exterior conductor pins into the three electrical phase groups, and the axis of the cylinder being coaxial with an axis of the heater.

18. The heater according to claim 17, wherein the phase divider has a length along the axis of the cylinder that is at least equal to a distance the exterior conductor pins protrude from the exterior header plate.

19. The heater according to claim 17, further comprising:
an exterior cavity within the exterior end of each of the tubes, the exterior conductor pin extending through the exterior cavity;
an exterior insulating member having a passage through which the exterior conductor pin extends, a cylindrical shank that is located in the exterior cavity and a cylindrical head protruding from the exterior end of the tube; and
a layer of epoxy located between the shank of the exterior insulating member and the powder and between the exterior conductor pin and the passage in the exterior insulating member.

20. The heater according to claim 20, further comprising:
a cylindrical housing mounted to an exterior side of the exterior header plate and enclosing the exterior conductor pins; and wherein
the phase divider is located within the housing.
